(19) United States
(12) Patent Application Publication
(10) Pub. No.: US 2012/0087385 A1
(43) Pub. Date: Apr. 12, 2012

(54) FLARE FOR BATTLEFIELD ILLUMINATION

(76) Inventors: David B. Oakes, Reading, MA (US); Kristin L. Galbally-Kinney, Littleton, MA (US); Richard T. Wainner, Somerville, MA (US); William J. Kessler, Groton, MA (US)

(21) Appl. No.: 13/270,796

(22) Filed: Oct. 11, 2011

Related U.S. Application Data
(60) Provisional application No. 61/391,416, filed on Oct. 8, 2010.

(51) Int. Cl. H01S 3/04

(52) U.S. Cl. 372/34

(57) ABSTRACT

An infrared flare includes at least one diode laser configured to emit radiation in a near-infrared spectrum and an optical system configured to transform the radiation output from the at least one diode laser. Each of the at least one diode lasers are coupled to a laser mount. The infrared flare further includes a thermal management system configured to absorb waste heat generated by the at least one diode laser. The thermal management system is configured to maintain the laser mount at or below 60° C. during operation of the infrared flare.

### RELATED APPLICATIONS

This application claims the benefit of and priority to U.S. Provisional Application No. 61/391,416, filed on Oct. 8, 2010, the content of which is herein incorporated by reference in its entirety.

### GOVERNMENT RIGHTS

The invention was made with government support from the U.S. Army under contract numbers W31P4Q-09-C-0472, W31P4Q-10-P-0395, and W31P4Q-11-C-0102. The government may have certain rights in the invention.

### FIELD OF THE INVENTION

The invention relates generally to flares for providing uniform illumination, and more particularly, to infrared flares providing uniform illumination for night vision systems and devices.

### BACKGROUND

The U.S. Army uses the M-278 infrared flare for battlefield illumination. The flare incorporates a candle that burns a propellant (magnesium sodium nitrate) that produces 250 W/sr of infrared illumination (0.7-1.1 μm) and approximately 1 W/sr of visible illumination. Three limitations of the M-278 flare have been identified: 1) the propellant combustion is inherently unsteady, which results in a variation of the illumination intensity and duration; 2) the visible signature of the flare limits its usefulness in covert activities; and 3) burning propellant that reaches the ground may create a fire hazard.

### SUMMARY OF THE INVENTION

The invention, in one embodiment, can provide steady, near-infrared (NIR) illumination on a battlefield to enhance visibility for personnel utilizing night vision technology (e.g., night vision goggles). One or more high efficiency near-IR laser diodes can be combined with a compact, lightweight optical system that efficiently collects spatially non-uniform output from the one or more lasers and produces a uniform illumination field with a controlled divergence. The flare can include an illumination source, an optical system, a thermal management system, and an electrical power system. The flare can replace the propellant based candle of existing flares with a narrow spectral band diode laser source that can provide a steady, continuous and covert (e.g., near-IR wavelengths with little or no visible component) illumination source, and can eliminate the potential fire hazard of the conventional M-278 flare.

The flare can be deployed from the air or from the ground. The flare can collect radiation and direct it to the ground while it falls after deployment from an aircraft, such as a plane, helicopter or rocket, or after delivery from a mortar or rocket launcher. The flare can include a parachute, and fall to the ground at about 13 feet/second. In certain embodiments, the flare can maintain a constant illumination steradiancy as it descends. In some embodiments, the flare can provide a progressively larger illumination steradiancy as it descends to maintain a nearly constant illumination area on the ground.

In one aspect, an infrared flare comprises at least one diode laser configured to emit radiation in the near-infrared spectrum, and an optical system configured to transform the radiation output from the at least one diode laser. Each of the at least one diode lasers are coupled to a laser mount. The infrared flare further comprises a thermal management system configured to absorb waste heat generated by the at least one diode laser. The thermal management system is configured to maintain the laser mount at or below 60° C. during operation of the infrared flare.

In another aspect, an infrared flare comprises a cylindrical housing and a heat sink secured within the cylindrical housing. The infrared flare further comprises an illumination source secured within the cylindrical housing. The illumination source is coupled to an illumination source mount at a first end of the heat sink, and is configured to emit radiation in the near-infrared spectrum. The infrared flare further comprises an electrical power system secured within the cylindrical housing and coupled to a second end of the heat sink. The heat sink is configured to absorb waste heat generated by the illumination source and the electrical power system.

In another aspect, an infrared flare comprises means for emitting radiation in the near-infrared spectrum, means for transforming the radiation output from the means for emitting, means for absorbing waste heat generated by the means for emitting, and means for coupling the means for emitting to the means for absorbing. The means for absorbing waste heat is configured to maintain the means for coupling at or below 60° C. during operation of the infrared flare.

In another aspect, an infrared flare system comprises an illumination subsystem including at least one diode laser source configured to provide radiation in the near-infrared spectrum, and an optical subsystem configured to remove astigmatism and laser speckle from an output of the at least one diode laser and to transform the output of the at least one laser diode into a Gaussian profile or a flat-top profile. The optical subsystem is further configured to provide uniform illumination. The infrared flare further comprises an electronic power control system including a thermal battery configured to supply an operating current to the illumination subsystem, and a thermal management subsystem including a heat sink and a phase change material. The heat sink and the phase change material are configured to absorb waste heat generated by the flare.

In another aspect, a method of providing uniform illumination using a flare comprises receiving an output in the near-infrared spectrum from at least one diode laser, removing laser speckle from the output of the at least one diode laser, and transforming the output from the at least one diode laser into a Gaussian profile or a flat top profile.

In some embodiments, the at least one diode laser is configured to emit radiation having a wavelength ranging between 800 nm and 950 nm.

In some embodiments, the optical system includes at least one light shaping diffuser configured to transform an astigmatic output of the at least one diode laser into a flat top illumination profile.

In some embodiments, the at least one light shaping diffuser is further configured to remove laser speckle from the output of the at least one diode laser.

In some embodiments, the optical system includes a compound parabolic reflector that is configured to collect and concentrate the radiation emitted by the at least one diode laser.

In some embodiments, the compound parabolic reflector is configured to improve the spatial uniformity of the radiation emitted by the at least one diode laser.

In some embodiments, the optical system receives the radiation emitted by the at least one laser diode. The optical system can be configured to provide at least a 1.26 steradian coverage of radiation with greater than 40% uniformity.

In some embodiments, the infrared flare further comprises a battery configured to supply an operating current to the at least one diode laser. The battery can include a thermal battery.

In some embodiments, the at least one laser diode and the thermal management system are secured within a cylindrical housing. The cylindrical housing can be mechanically compatible with the M-278 flare package standard.

In some embodiments, the laser mount is coupled to a heat sink of the thermal management system. The heat sink can include a phase change material that is capable of absorbing the waste heat generated by the at least one laser diode coupled to the laser mount.

In some embodiments, a cavity of the heat sink is filled with an open structure impregnated with the phase change material.

In some embodiments, the heat sink is configured to maintain the illumination source mount at or below 60° C. during operation of the infrared flare.

In some embodiments, the heat sink includes a cylindrical body secured within the cylindrical housing. The cylindrical body of the heat sink can include at least one cavity filled with a phase change material.

In some embodiments, the at least one cavity is filled with an open cell structure impregnated with the phase change material. The open cell structure can be configured to increase the heat transfer rate into the phase change material.

In some embodiments, the open cell structure includes one of an aluminum foam or a graphite foam.

In some embodiments, the infrared flare comprises at least one light shaping diffuser configured to transform an astigmatic output of the illumination source into a flat top illumination profile or a Gaussian profile.

In some embodiments, the at least one light shaping diffuser is configured to remove laser speckle from the output of the illumination source.

In some embodiments, the illumination source includes a plurality of laser diodes that are configured to emit radiation having a wavelength ranging between 800 nm to 950 nm.

In some embodiments, the infrared flare is configured to provide an illumination altitude of about 400 meters to about 1000 meters.

In some embodiments, the infrared flare is configured to provide an illumination area of at least 1500 meters in diameter.

In some embodiments, the infrared flare has an electrical to optical efficiency of at least 50% at a temperature up to 60° Celsius.

In some embodiments, the infrared flare has a flare life of at least 180 seconds.

In some embodiments, the infrared flare weighs less than or equal to 6.95 pounds.

In some embodiments, the optical system comprises at least one concentrating parabolic reflector and at least one light shaping diffuser.

In some embodiments, the method further comprises delivering the Gaussian profile or the flat top profile to uniformly illuminate a field of view of night vision goggles.

In some embodiments, the at least one laser diode includes a plurality of laser diodes.

In some embodiments, the method further comprises combining the output from the plurality of laser diodes.

### BRIEF DESCRIPTION OF THE DRAWINGS

The foregoing and other objects, features and advantages of embodiments of the invention will be apparent from the more particular description of preferred embodiments, as illustrated in the accompanying drawings in which like reference characters refer to the same elements throughout the different views. The drawings are not necessarily to scale, emphasis instead being placed upon illustrating the principles of the preferred embodiments.

FIG. 1 is a perspective view of a flare.

FIGS. 2A and 2B are cross-sectional views of flares.

FIG. 3 is a perspective view of a heat sink.

FIG. 4 is a graph illustrating an angular profile of a batwing diffuser.

### DETAILED DESCRIPTION OF THE INVENTION

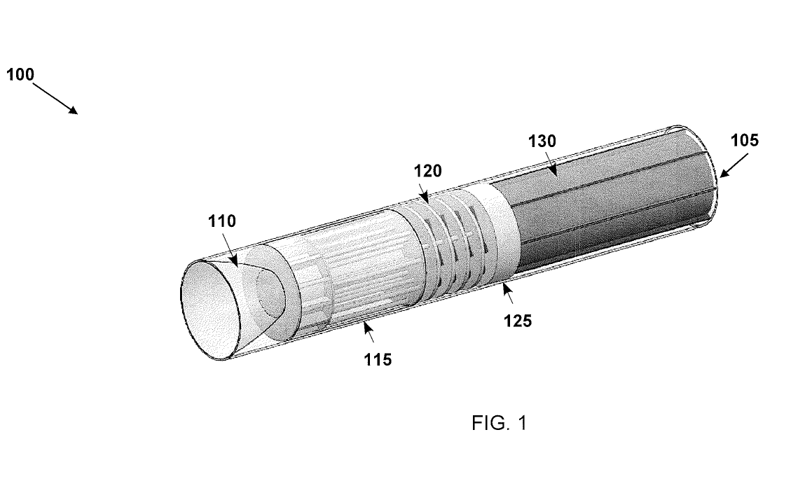

FIG. 1 is a perspective view of a flare 100 including a cylindrical housing 105. In some embodiments, various flare components are secured to or coupled to the cylindrical housing 105. For example, in the embodiment shown in FIG. 1, a laser mount and heat sink 115, a power conditioning device 120, an electronics control module 125 and a battery 130 are secured within the cylindrical housing 105. In some embodiments, the various flare components are integral with the cylindrical housing 105. For example, the laser mount and heat sink 115 can be integrally formed with the cylindrical housing 115. An optional optical device 110 can be secured fully or partially within the cylindrical housing 105 such that the optical device 110 abuts the laser mount and heat sink 115. The optical device 110 can be secured to an outer opening of the cylindrical housing 105.

The cylindrical housing 105 can be formed of aluminum, stainless steel, steel, titanium, brass, magnesium or a combination thereof. In some embodiments, the cylindrical housing 105 can be formed of a plastic material, such as a high impact thermoplastic material.

The flare 100 can be mechanically compatible (size and weight) with the existing M-278 flare package. In this manner, the flare 100 can be deployed from existing M-278 flare deployment systems and devices. For example, the flare 100 can be dimensioned to fit within the 15.4 inch length and the 2.65 inch inner diameter requirement of the existing M-278 flare package. The flare 100 can be constructed and arranged to weigh about 2.5 kg (5.5 lbs), which is less than the maximum allowed weight (6.95 lbs) of the M-278 flare package.

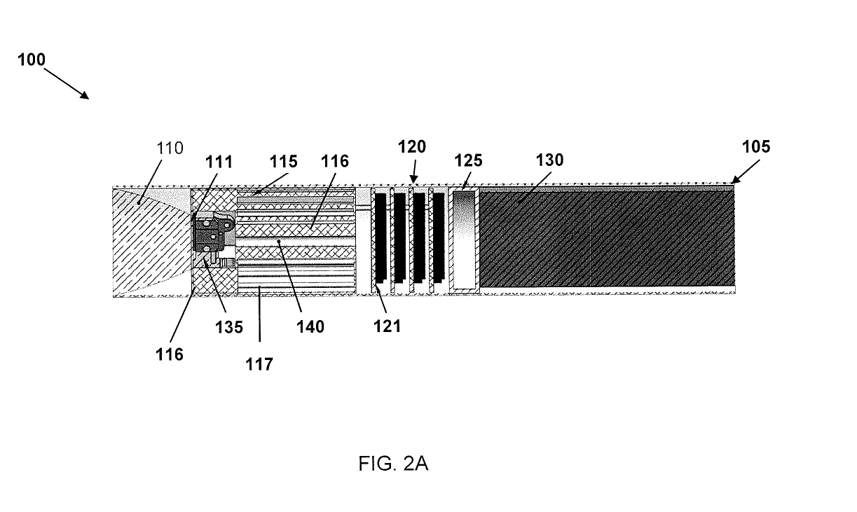

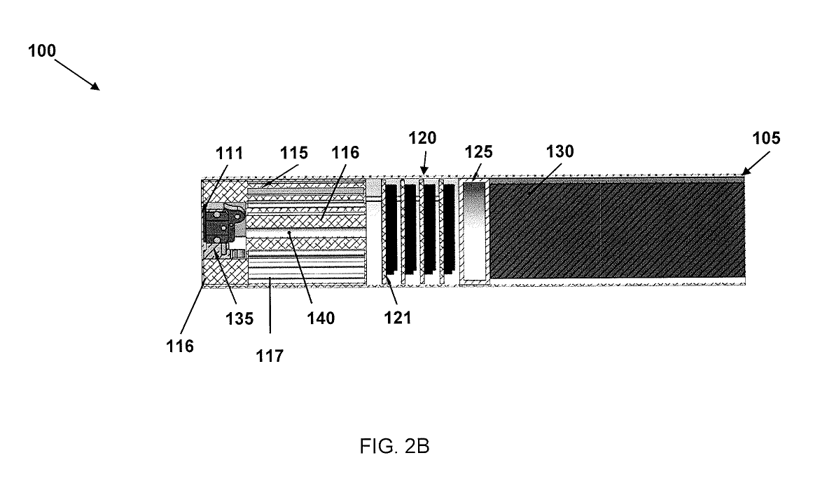

FIGS. 2A and 2B are cross-sectional views of flares. FIG. 2A shows an exemplary flare 100 that includes an optional optical device 110 secured within the cylindrical housing 105, and FIG. 2B shows an exemplary flare 100 without the optional optical device 110.

Referring to FIG. 2A, the optical device 110 includes a parabolic reflector, such as a compound parabolic reflector (CPR) that is configured to improve the spatial uniformity of light generated by the flare 100. In some embodiments, the parabolic reflector is concentrating. An example of a compound parabolic concentrator is available from Edmund Scientific (Stock No. M63-229) of Barrington, N.J.

The flare 100 includes one or more light shaping diffusers (LSD) 111 coupled to the light emitting end of the laser mount and heat sink 115. The LSD 111 can be configured to convert a highly astigmatic output of the illumination source 135 into a uniform Gaussian profile or flat top illumination profile. The LSD 111 can be elliptical or elliptical/batwing. Luminit LLC of Torrance, Calif. manufactures a variety of stock elliptical LSDs available and can also custom fabricate LSDs to desired specifications. RPC Photonics Inc of Rochester, N.Y. also designs and manufactures custom elliptical or elliptical/batwing LSDs.

In some embodiments, such as the embodiment shown in FIG. 2A, the LSD 111 is coupled between the optional optical device 110 and the light emitting end of the laser mount and heat sink 115. The optical device 110 can include a parabolic reflector configured to improve the spatial uniformity of the light exiting the LSD 111 of the flare 100. In this configuration, the combination of the LSD 111 and the parabolic reflector of the optical device 110 can achieve less than a 40% variation of illumination intensity across the illumination field. In addition, the combination of the LSD 111 and the parabolic reflector of the optical device 110, or the LSD 111 alone, can be provided to remove a laser speckle from the illumination source 135.

In some embodiments, the combined efficiency of the LSD 111 and the parabolic reflector of the optical device 110 can be at least 87%. The combined efficiency can be greater than 90%. For example, the flare 100 can be configured to provide a 1.26 steradian coverage with better than 40% uniformity at 87% throughput efficiency. In some embodiments, at least 314 W of illumination can be delivered at 1.26 steradians.

The flare 100 can include one or more illumination sources 135, such as diode lasers or other light emitting sources, which can be coupled to the laser mount and heat sink 115. The laser mount and heat sink 115 is constructed and arranged to remove waste heat (joule heat) generated by the one or more illumination sources 135. In some embodiments, the laser mount and heat sink 115 includes a cavity that can be filled with a phase change material 116 or an open cell structure impregnated with a phase change material 116. Further, the heat sink 115 can include one or more heat pipes 117 for distributing waste heat (joule heat) within the phase change material 116 or open cell structure 116. The laser mount and heat sink 115 can also include a wire feed through cavity 140 for housing electrical conduits or wires that connect the one or more illumination sources 135 with the electrical power system (e.g., power conditioning device 120, electronics control module 125, a battery 130) of the flare 100.

In some embodiments, in which waste heat is efficiently distributed into a heat sink, a 50% efficiency at a 60° C. operating temperature can be achieved from one or more laser diodes. This high efficiency operation at high temperatures enables the flare 100 to include as few as one or two illumination sources 135 to generate the illumination output of the flare 100. Since diode lasers (−50% efficient) tend to be more efficient than light emitting diodes (LEDs)(25% efficient), diode lasers can be used as the illumination source in the flare 100 because illumination source efficiency directly impacts the amount of energy that is carried onboard the flare 100. A high efficiency and compact illumination source, such as a the Model JDL-BAB-50-47-808-TE-60-2.0 laser diode, manufactured by Jenoptik AG of Jena, Germany, can meet the size, weight and illumination requirements of the flare 100.

For example, in some embodiments, the flare 100 is constructed and arranged to generate 300 W to 400 W of near-IR light to meet the illumination intensity requirements of the M-278 flare. The illumination source can include two or more laser diodes that can be configured as a parallel or series connected diode laser bar.

In some embodiments, an 808 nm diode laser bar including two or more parallel or series connected laser diodes can be configured to provide a 50% electrical-to-optical efficiency at 60° C. For example, the diode laser bar can include two diode lasers that provide a combined total of 370 W of near-IR light output at 60° C. Further, the diode lasers of the laser bar can be manufactured to incorporate an advanced thermal management package design that enables efficient operation at elevated mount temperatures. A minimum of two lasers can be used to achieve at least 370 W of near-IR light output. In some embodiments, three or more diode lasers can be used. Although various flare embodiments including diode lasers are described herein, other compact laser sources, such as solid state lasers and vertical cavity surface emitting lasers (VCSEL's) lasers can be provide as the illumination source in the flare embodiments shown and described herein.

The flare 100 can include an electrical power system including a power conditioning device 120, an electronics control module 125 and a battery 130. Each of the power conditioning device 120, the electronics control module 125 and the battery 130 can be secured within the housing 105 of the flare 100 and electrically connected to one another.

Generally, flares 100 of the type shown and described herein are designed to have an extended shelf-life (for example, about 10 years). In addition, the flares 100 can often consume a relatively high power for a short period of time (for example, about 180 seconds). To meet these requirements, the battery 130 can provide high power delivery with a high mass (W/kg) and volume (W/liter) power density, along with an extended shelf-life. Batteries 130 that meet the above criteria include thermal batteries, lithium ion batteries and other high energy density, extended-life energy storage devices.

The battery 130 is configured to supply an electrical current to the electronics control module 125 and the power conditioning device 120. The electronics control module 125 can include circuitry to turn on the supply of current from the battery and to control other flare functions (e.g. destroying the laser diodes after the desired illumination period). In some embodiments, the battery 130 can be constructed and arranged to supply a nominal 40 V at 21 amps, which can be down-converted by the power conditioning device 120 to 1.7 V and 435 amps. The power conditioning device 120 can include high efficiency (for example, at least 88%) power conditioning components that can be utilized to convert the voltage/current level supplied by the battery 130 to a proper voltage/current level required by the illumination source 135 and other flare components. A commercially available current regulated power conditioning circuit with >88% efficiency can be provided to generate 1.7 V and 435 amps to power the illumination source 135.

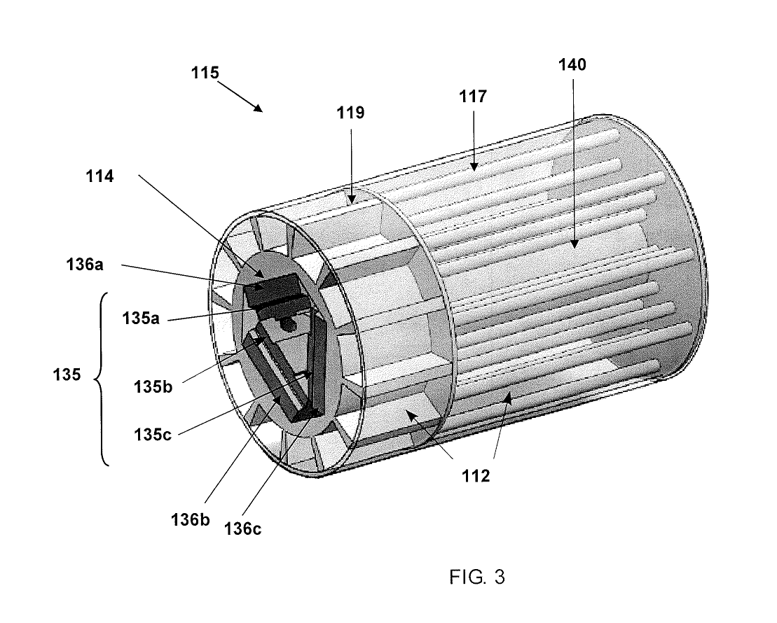

FIG. 3 is a perspective view of a heat sink. As described above, one or more illumination sources 135 can be coupled to the laser mount and heat sink 115 so that waste heat (joule heat) generated by the one or more illumination sources 135 during operation of the flare 100 is absorbed by the laser mount and heat sink 115. In addition, the laser mount and heat sink 115 can be constructed and arranged to absorb waste heat (joule heat) generated by the power conditioning device 120 of the flare 100.

To maintain the illumination sources 135 and the power conditioning device 120 of the flare 100 at proper operating temperatures, the laser mount and heat sink 115 can be designed to absorb an amount of waste heat (joule heat) equal to or greater than the waste heat (joule heat) generated by components of the flare 100 during its operation. As an example, if the waste heat (joule heat) generated by the illumination source 135 (370 W at 50% efficiency) and the power conditioning device 120 (82 W at 88% efficiency) over a 180 second operation of the flare 100 is given by the following Equation: (370 W+82 W)×180 s=81.4 kJ, the laser mount and heat sink 115 can be designed to absorb 81.4 kJ or more of waste heat (joule heat).

In FIG. 3, first through third illumination sources 135a-c are coupled to an inner cavity 114 of the laser mount and heat sink 155 via first through third mounts 136a-c. The laser mount and heat sink 115 is constructed and arranged to remove waste heat (joule heat) generated by the one or more illumination sources 135 so that the one or more illumination source 135 can operate more efficiently. In some embodiments, the laser mount and heat sink 115 is constructed and arranged to maintain mount 136a-c temperatures ranging between 50° C. and 60° C. during operation of the flare 100. In addition, the laser mount and heat sink 115 can be configured to abut the electronic power control system of the flare 100 so that the power conditioning device 120 of the flare 100 can be maintained at or below 100° C.

In some embodiments, the laser mount and heat sink 115 include one or more cavities 112 filled with a phase change material or an open cell structure impregnated with a phase change material to absorb the waste heat (joule heat) generated by the one or more illumination sources 135 (see for example, phase change material 116 or open cell structure 116 shown in FIGS. 2A and 2B). In some embodiments, the open cell structure includes aluminum foam or graphite foam, and can have a porosity greater than or equal to 0.9 (where porosity is defined by the fraction of void space in the material). The open cell structure or foam can be provided to improve the transfer of waste heat (joule heat) from the body of the heat sink into the phase change material, which has a relatively poor thermal conductivity. The latent heat of the melting of the phase change material ultimately absorbs a majority of the waste heat (joule heat) produced by the components of the flare 100.

Further, the heat sink 115 can include heat spreading components such as heat pipes 117 and/or heat fins 119 that are configured to distribute the waste heat generated by the one or more illumination sources 135. In embodiments including a phase change material or an open cell structure impregnated with a phase change material, the heat pipes 117 and/or heat fins can be configured to increase the waste heat (joule heat) absorption rate of the phase change material.

In some embodiments, the laser mount and heat sink 115 is fabricated from an aluminum material, such as 6061 aluminum, and can include an array of heat fins 119 that are configured to conduct waste heat (joule heat) away from the illumination source mounts 136a-c and into the bulk of the heat sink 115. In some embodiments, the laser mount and heat sink 115 are fabricated from other materials such as copper or graphite.

In some embodiments, the laser mount and heat sink 115 is constructed and arranged to have an open internal volume equal to about 270 cm³, which can be filled with a phase change material or open cell structure impregnated with a phase change material. In this exemplary embodiment, the laser mount and heat sink 115 can be filled with 345 g of sodium pentahydrate, which melts at 48° C. and has a heat of fusion of 267 J/g. In this configuration, the phase change material can absorb 92 kJ of thermal energy, which is sufficient to absorb the required thermal load for the flare 100. The phase change material can have a melting temperature of 56° C., and can fill 99% of an open volume of the open cell structure.

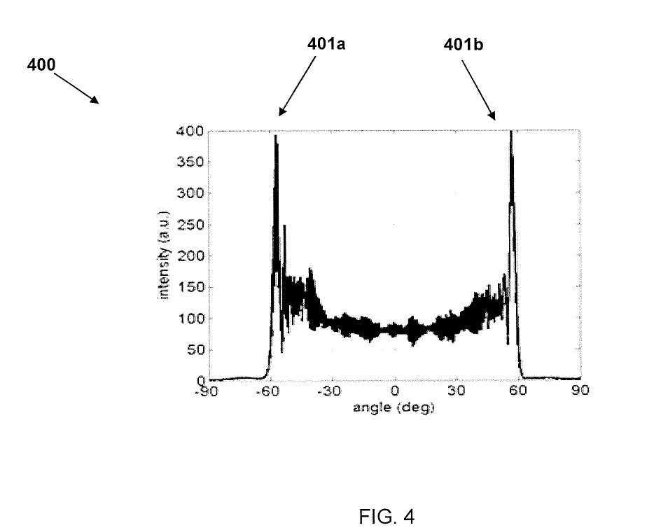

FIG. 4 is a graph illustrating an angular profile of a batwing diffuser available from RPC Photonics Inc (Rochester, N.Y.). The graph 400 shows an angular intensity profile produced by an LSD 111 configured as a batwing diffuser. In this configuration, the LSD 111 directs a higher fraction of diffused light into a prescribed angle at the edge of its illumination profile 401a-b. An LSD 111 designed with a batwing-type profile can be used to overcome the inherent cos³(θ) intensity fall-off that results from illuminating a flat surface (e.g. the ground) with a uniform illumination source in the far-field. In particular, an LSD 111 configured as an elliptical batwing diffuser can be used to simultaneously remove the inherent astigmatism in the output beam produced by an illumination source 135, such as diode laser or diode laser bar, and produce an angular profile that results in uniform illumination (W/m²) on the ground over a desired area.

Tables 1 through 3 list exemplary specifications for a flare. Table 1 lists characteristics of an embodiment of an infrared flare. Table 2 lists characteristics and specifications of subsystems of an embodiment of an infrared flare. Table 3 lists mass allocations for an embodiment of an infrared flare.

TABLE 1
Specifications for the Solid-State Infrared Flare

| Parameter | Value/Range |
|---|---|
| 1) Spectral Range | 800-950 nm |
| 2) Optical Power Out:Duration | 314 W:180 s |
| 3) Illumination Area on Ground | 1500 m |
| 4) Illumination Altitude | 1000 m-400 m |
| 5) Illumination Uniformity | ≧40% goal |
| 6) Package dimensions | Fit in 2.65″ ID, 15.4″ long volume |
| 7) Integrated Weight | ≦6.95 lbs |
| 8) Operational Temperature | −25-140 F. |
| 9) Unattended Shelf Life | 10 years |
| 10) Cost (light + power systems) | ≦$2,000 |

TABLE 2
Flare Subsystems and Specifications

| Flare | |
|---|---|
| Subsystems | Characteristics |
| Illumination | 1) Output wavelength: 800-950 nm |
| Source | 2) Output power: 370 W |
| | 3) Optical to Electrical Efficiency Goal: 50% at 60 C. |
| Optics | 1) Optical efficiency Goal: ≧85% |
| | 2) Output ≧ 314 W into 1.26 sr with ≧40% uniformity |
| Thermal | 1) Passive cooling: Maintain laser mount ≦60 C. |
| Management | 2) 81.4 kJ capacity for cooling laser + electronics |
| Electrical | 1) Battery ≧ 850 W for 180 s: <1.6 kg and <7-in length |
| Power | 2) Power conditioning for diode laser: 1.7 V and 435 amps |

TABLE 3

| Flare Components | Mass (g) |
|---|---|
| Battery | 1600 |
| Power Conditioning | 223 |
| Heat Sink | 546 |
| Light Source + Optics | 122 |
| Flare Housing | 289 |
| Total Mass | 2780 |

While the invention has been particularly shown and described with reference to specific illustrative embodiments, it should be understood that various changes in form and detail can be made without departing from the spirit and scope of the invention.

1. An infrared flare comprising:
at least one diode laser configured to emit radiation in the near-infrared spectrum, each of the at least one diode lasers coupled to a laser mount;
an optical system configured to transform the radiation output from the at least one diode laser; and
a thermal management system configured to absorb waste heat generated by the at least one diode laser, wherein the thermal management system is configured to maintain the laser mount at or below 60° C. during operation of the infrared flare.

2. The infrared flare of claim 1 wherein the at least one diode laser is configured to emit radiation having a wavelength ranging between 800 nm and 950 nm.

3. The infrared flare of claim 1 wherein the optical system includes at least one light shaping diffuser configured to transform an astigmatic output of the at least one diode laser into a flat top illumination profile.

4. The infrared flare of claim 3 wherein the at least one light shaping diffuser is further configured to remove laser speckle from the output of the at least one diode laser.

5. The infrared flare of claim 3 wherein the optical system includes a compound parabolic reflector that is configured to collect and concentrate the radiation emitted by the at least one diode laser.

6. The infrared flare of claim 5 wherein the compound parabolic reflector is further configured to improve the spatial uniformity of the radiation emitted by the at least one diode laser.

7. The infrared flare of claim 1 wherein the optical system receives the radiation emitted by the at least one laser diode, and wherein the optical system is further configured to provide at least a 1.26 steradian coverage of radiation with greater than 40% uniformity.

8. The infrared flare of claim 1 further comprising a battery configured to supply an operating current to the at least one diode laser.

9. The infrared flare of claim 8 wherein the battery includes a thermal battery.

10. The infrared flare of claim 1 wherein the at least one laser diode and the thermal management system are secured within a cylindrical housing, the cylindrical housing mechanically compatible with the M-278 flare package standard.

11. The infrared flare of claim 1 wherein the laser mount is coupled to a heat sink of the thermal management system, the heat sink including a phase change material that is capable of absorbing the waste heat generated by the at least one laser diode coupled to the laser mount.

12. The infrared flare of claim 11 wherein a cavity of the heat sink is filled with an open structure impregnated with the phase change material.

13. The infrared flare of claim 12 wherein the open cell structure includes one of an aluminum foam or a graphite foam.

14. An infrared flare comprising:
a cylindrical housing;
a heat sink secured within the cylindrical housing;
an illumination source secured within the cylindrical housing and coupled to an illumination source mount at a first end of the heat sink, the illumination source configured to emit radiation in the near-infrared spectrum; and
an electrical power system secured within the cylindrical housing and coupled to a second end of the heat sink,
wherein the heat sink is configured to absorb waste heat generated by the illumination source and the electrical power system.

15. The infrared flare of claim 14 wherein the heat sink is configured to maintain the illumination source mount at or below 60° C. during operation of the infrared flare.

16. The infrared flare of claim 14 wherein the heat sink includes a cylindrical body secured within the cylindrical housing, the cylindrical body including at least one cavity filled with a phase change material.

17. The infrared flare of claim 16 wherein the at least one cavity is filled with an open cell structure impregnated with the phase change material, wherein the open cell structure is configured to increase the heat transfer rate into the phase change material.

18. The infrared flare of claim 17 wherein the open cell structure includes one of an aluminum foam or a graphite foam.

19. The infrared flare of claim 14 further comprising at least one light shaping diffuser configured to transform an astigmatic output of the illumination source into a flat top illumination profile or a Gaussian profile.

20. The infrared flare of claim 19 wherein the at least one light shaping diffuser is further configured to remove laser speckle from the output of the illumination source.

21. The flare of claim 14 wherein the illumination source includes a plurality of laser diodes that are configured to emit radiation having a wavelength ranging between 800 nm to 950 nm.

22. The infrared flare of claim 14 wherein the infrared flare is configured to provide an illumination altitude of about 400 meters to about 1000 meters.

23. The infrared flare of claim 14 wherein the infrared flare is configured to provide an illumination area of at least 1500 meters in diameter.

24. The infrared flare of claim 14 wherein the infrared flare has an electrical to optical efficiency of at least 50% at a temperature up to 60° Celsius.

25. The infrared flare of claim 14 wherein the infrared flare has a flare life of at least 180 seconds.

26. The infrared flare of claim 1 wherein the infrared flare weighs less than or equal to 6.95 pounds.

27. An infrared flare comprising:
means for emitting radiation in the near-infrared spectrum;
means for transforming the radiation output from the means for emitting; and
means for absorbing waste heat generated by the means for emitting,
means for coupling the means for emitting to the means for absorbing, wherein the means for absorbing waste heat is configured to maintain the means for coupling at or below 60° C. during operation of the infrared flare.

28. An infrared flare system comprising:
an illumination subsystem including at least one diode laser source configured to provide radiation in the near-infrared spectrum;
an optical subsystem configured to remove astigmatism and laser speckle from an output of the at least one diode laser and to transform the output of the at least one laser diode into a Gaussian profile or a flat-top profile, the optical subsystem further configured to provide uniform illumination;
an electronic power control system including a thermal battery configured to supply an operating current to the illumination subsystem; and
a thermal management subsystem including a heat sink and a phase change material, wherein the heat sink and the phase change material are configured to absorb waste heat generated by the flare.

29. The infrared flare system of claim 28 wherein the optical system comprises at least one concentrating parabolic reflector and at least one light shaping diffuser.

30. A method of providing uniform illumination using a flare, comprising:
receiving an output in the near-infrared spectrum from at least one diode laser;
removing laser speckle from the output of the at least one diode laser; and
transforming the output from the at least one diode laser into a Gaussian profile or a flat top profile.

31. The method of claim 30 further comprising delivering the Gaussian profile or the flat top profile to uniformly illuminate a field of view of night vision goggles.

32. The method of claim 30 wherein the at least one laser diode includes a plurality of laser diodes.

33. The method of claim 32 further comprising combining the output from the plurality of laser diodes.
